(19) United States
(12) Patent Application Publication
(10) Pub. No.: US 2005/0151717 A1
(43) Pub. Date: Jul. 14, 2005

(54) Backlight control circuit in portable device

(75) Inventor: Jae-Min Seo, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/917,134

(22) Filed: Aug. 12, 2004

(30) Foreign Application Priority Data
Dec. 18, 2003 (KR) 93185/2003

(51) Int. Cl. G09G 3/36

(52) U.S. Cl. 345/102

(57) ABSTRACT

Disclosed is a backlight control circuit capable of decreasing current applied to an illuminating device or turning off a portion of illuminating devices if an illuminating time exceeds a predetermined reference time when the illuminating device is in a turned-on state, or a thermal emission temperature of the illuminating device is higher than a predetermined reference temperature. Accordingly, it is possible to reduce current consumption and thermal emission of the illuminating device resulting from continuous turn-on states of the illuminating device while using a backlight function.

### PRIORITY

This application claims priority to an application entitled “Backlight Control Circuit In Portable Device” filed in the Korean Intellectual Property Office on Dec. 18, 2003 and assigned Serial No. 2003-93185, the contents of which are hereby incorporated by reference.

### BACKGROUND OF THE INVENTION

1. Field of the Invention

The present invention relates to a portable device, and more particularly to a circuit allowing an illuminating device to provide backlight for the portable device.

2. Description of the Related Art

In general, a liquid crystal display (LCD) is widely used as a display unit of portable devices such as a mobile communication terminal, a smart phone, and so forth. The LCD itself does not emit light, unlike a cathode ray tube (CRT), an electroluminescence element (EL), and so forth. Therefore, additional illumination is required for an LCD screen in such a manner to illuminate images are visually displayed on the LCD screen. To this end, a portable device employing an LCD as a display unit has a backlight function for illuminating the LCD screen. Also, the backlight function is used in order to allow a user to recognize key buttons of the portable device in a dark place. In the portable device including the backlight function for the LCD screen and/or the key buttons as described above, a light emitting diode (LED) is typically used as the illuminating device for backlight.

In a portable device having a backlight function, users may selectively use the backlight function according to their needs. When a user selects the backlight function in the portable device, if events, such as the cover (or flip or folder) opening, call incoming, and an alarm, occur, an illuminating device of the portable device is turned on. If the cover is closed, a key input does not occur for a predetermined time, or the call incoming or the alarm is terminated, the illuminating device, which has been turned on, is switched into a turned-off state.

Meanwhile, when a user accesses a mobile Internet, an audio response system (ARS), or a voice mailing system (VMS), the user may continuously perform an key input operation in the usual manner. In this case, since the illuminating device constantly maintains a turned-on state due to continuous key inputs, current is continuously consumed and a volume of thermal emission of the illuminating device increases. For this reason, available time of battery power may be shortened and the user may feel uneasy or displeasure due to the thermal emission generated by the battery. These kinds of problems may not occur if the user does not use the backlight function. However, the user inevitably uses the backlight function in dark places.

### SUMMARY OF THE INVENTION

Accordingly, the present invention has been made to solve the above-mentioned problems occurring in the prior art, and a first object of the present invention is to provide a backlight control circuit capable of reducing current consumption resulting from a continuous turn-on state of an illuminating device while using a backlight function.

A second object of the present invention is to provide a backlight control circuit capable of reducing thermal emission of a battery resulting from a continuous turn-on state of an illuminating device while using a backlight function.

In order to accomplish these objects, according to an aspect of the present invention, there is provided a backlight control circuit capable of decreasing current applied to an illuminating device or partially turning off illuminating devices if an illuminating time exceeds a predetermined threshold time when the illuminating device is in a turned-on state or a thermal emission temperature of the illuminating device is higher than a predetermined threshold temperature.

### BRIEF DESCRIPTION OF THE DRAWINGS

The above and other objects, features and advantages of the present invention will be more apparent from the following detailed description taken in conjunction with the accompanying drawings, in which:

FIG. 1 shows a backlight control circuit according to a first embodiment of the present invention;

FIG. 2 is a flow chart representing a backlight control procedure according to the first embodiment of the present invention;

FIG. 3 shows a backlight control circuit according to a second embodiment of the present invention;

FIG. 4 shows a backlight control circuit according to a third embodiment of the present invention; and

FIG. 5 is a flow chart representing a backlight controlling procedure according to the third embodiment of the present invention.

### DETAILED DESCRIPTION OF THE PREFERRED EMBODIMENT

Hereinafter, preferred embodiments of the present invention will be described in detail with reference to the accompanying drawings. The same or similar components in the drawings may be designated by the same reference numerals although they are shown in different drawings. In the following description of the present invention, a detailed description of known functions and configurations incorporated herein will be omitted when it may make the subject matter of the present invention unclear.

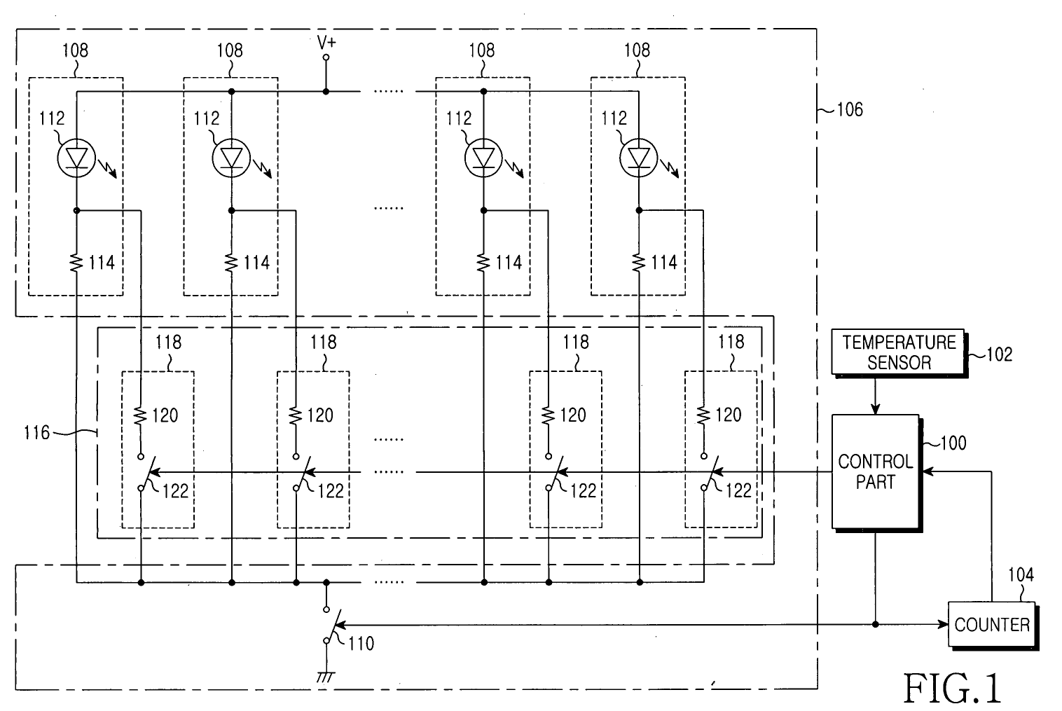

The backlight control circuit according to a first embodiment of the present invention is shown in FIG. 1, and includes a temperature sensor 102, a counter 104, and a current controlling part 116 in order to control backlight through a conventional backlight circuit 106 controlling on/off switching of illuminating devices by a control part 100. The backlight circuit 106 employs light emitting diodes (LEDs) 112 as illuminating devices for illuminating liquid crystal displays (LCDs), key buttons and so forth included in portable devices using the backlight control circuit shown in FIG. 1. Plural sets of the LEDs 112 and resistors 114 are connected to each other in series between a voltage source terminal (V+) and a ground by interposing a backlight controlling switch 110 therebetween. The backlight controlling switch 110 is used for turning on/off the LEDs 112 and is switched under the control of the control part 100.

The control part 100 turns on the backlight controlling switch 110 when a backlight function is executed and turns off the backlight controlling switch 110 when the backlight function is not executed. The control part 100 employs a chip such as “MSM (Mobile Station Modem)” of QUALCOMM Co. if a portable device having the backlight circuit 106 is a mobile communication terminal using CDMA (code division multiple access). If the backlight controlling switch 110 is turned on, a current path is formed from the voltage source terminal (V+) to the ground through plural sets 108 of the LED 112 and the resistor 114, so that the LEDs 112 are turned on. The current path formed as described above is cut off if the backlight controlling switch 110 is turned off, so that the LEDs 112 are turned off.

The temperature sensor 102 is installed adjacent to or near to the LEDs 112 in order to measure temperatures resulting from thermal emission of the LEDs 112 when the LEDs 112 are turned on, and provides the temperatures to the control part 100. It is preferred that a digital temperature sensor, which outputs measured temperature values as digital data, is used as the temperature sensor 102. The counter 104 is used for checking a turn-on time of the LEDs. The counter 104 receives on/off signals applied to the backlight controlling switch 110 from the control part 100 and counts the time while an on-signal is inputted to the counter 104 so as to provide the control part 100 with time value data. In addition, the counter 104 is reset when an off-signal is inputted to the counter 104.

The control part 100 checks the thermal emission temperature of the LEDs 112 by using the temperature sensor 102, and the illumination time counted by the counter 104 according to the present invention. If the illumination time exceeds a predetermined reference time or the thermal emission temperature of the LEDs is higher than a predetermined reference temperature, the control part 100 reduces current applied to the LEDs 112 by using the current controlling part 116. To this end, the current controlling part 116 includes plural sets 118 of a resistor 120 and a current controlling switch 122 connected to each other in series. Therefore, the current controlling part 116 controls current applied to the LEDs 112 under the control of the control part 100. Plural sets 118 of the resistor 120 and the current controlling switch 122 correspond to plural sets 108 of the LED 112 and the resistor 114. Also, plural sets 118 of the resistor 120 and the current controlling switch 122 are connected to plural sets 108 of the LED 112 and the resistor 114 in parallel, respectively. If the current controlling switch 122 is turned on, current paths connecting the resistors 114 and 120 to each other in parallel are formed between the LED 112 and the ground through the backlight controlling switch 110. In contrast, if the current controlling switch 122 is turned off, a path of current flowing only through the resistor 114 is formed between the LED 112 and the ground through the backlight controlling switch 110. Accordingly, an amount of current will decrease if the current controlling switch 122 is turned off than when the current controlling switch 122 is turned on. Accordingly, the resistors 114 and 112 are designed in such a manner that a value of a parallel resistor combination of the resistors 114 and 112 is equal to a resistance value of a resistor according to the conventional backlight circuit corresponding to the resistor 114 of the conventional backlight circuit. In addition, a resistance value of the resistor 114 according to the present invention is determined in such a manner that the resistance value of the resistor 114 is larger than that of the resistor of the conventional backlight circuit.

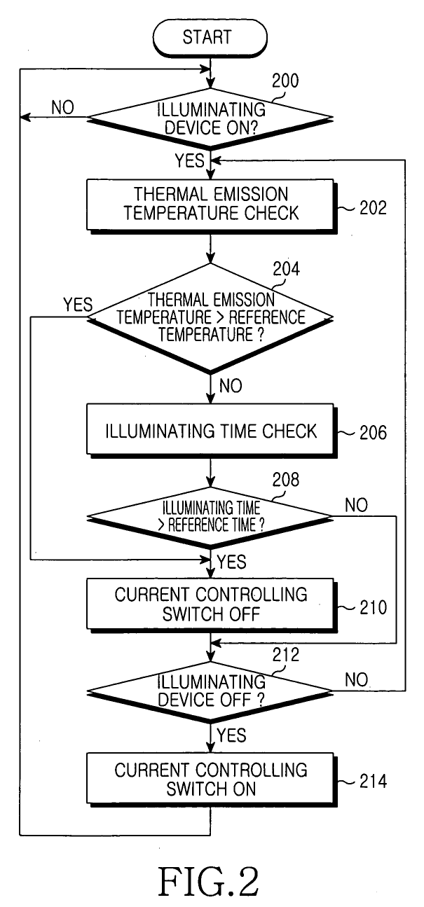

FIG. 2 is a flow chart showing a backlight controlling operation by the control part 100. Herein, the backlight controlling operation occurs with the control part 100 decreasing an amount of current applied to the LEDs 112 by means of the current controlling part 116 if an illuminating time exceeds a reference time or a thermal emission temperature of the LEDs 112 is higher than the reference temperature after checking the illuminating time and the temperature. If it is necessary to execute the backlight function, the control part 100 turns on the LEDs 112 (illuminating devices) by turning on the backlight controlling switch 110 at step 200. At this time, the current controlling switches 122 maintain turn-on states and the counter 104 starts to count the illuminating time as the backlight controlling switch 110 is turned on by the control part 100.

In this state, the control part 100 checks the thermal emission temperature of the LEDs 112, which is measured by the temperature sensor 102 at step 202. The control part 100 compares the thermal emission temperature with the reference or threshold temperature in step 204. If the thermal emission temperature is higher than the reference temperature, the control part 100 turns off the switch 122 at step 210. If the thermal emission temperature does not exceed than the reference temperature, the control part 100 then checks the illumination time at step 206. The control part 100 checks the illuminating time counted by the counter 104 in step 206 and compares the illuminating time with the reference or threshold time in step 208. If the illuminating time exceeds the reference time, the control part 100 turns off switch 122 at step 210. If the illuminating time does not exceed the reference time, the control part 100 checks to see if the LEDs 112 are off at step 212.

The control part 100 turns off the current controlling switches 122 in step 210. As a result, a volume of current flowing through the LEDs 12 decreases. In addition, the control part 100 checks whether or not the illuminating devices LEDs 112 are turned off in step 212. If the control part 100 turns off the LEDs 112 through the backlight controlling switch 110 in order to terminate the backlight function, the control part 100 returns to step 200 after turning on the current controlling switch 122 again in step 214. In contrast, if the control part 100 allows the LEDs 112 to maintain turn-on states in order to continuously execute the backlight function, the control part 100 proceeds to step 202.

Accordingly, when the thermal emission temperature of the LEDs 112 is higher than the reference temperature of the LEDs 112 or the illuminating time exceeds the reference time as the LEDs 112 continuously maintain turn-on states, the control part 100 reduces a volume of the current flowing through the LEDs 112, so that it is possible to reduce current consumption resulting from continuous turn-on states of the illuminating devices and to reduce thermal emission of the LEDs 112 while using a backlight function.

To this end, the reference time and the reference temperature are established through field tests by manufacturing companies in such a manner that an illumination temperature maintains a predetermined temperature capable of preventing a user from feeling uneasy and displeased by the heat generated by the portable terminal of the present invention, even if the LEDs continuously maintain turn-on states in the event the user continuously carries out the key operation as described above.

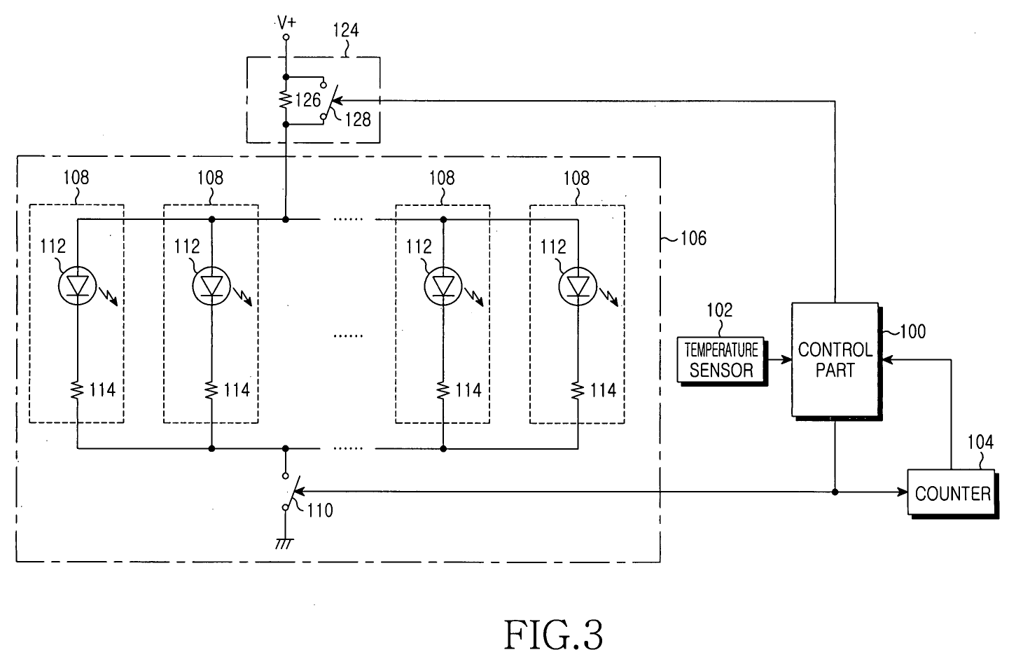

FIG. 3 is a view showing a backlight control circuit according to a second embodiment of the present invention. In contrast to the backlight control circuit shown in FIG. 1, which individually controls current flowing through the LEDs 112 by connecting each LED 112 to each current controlling switch 122, the backlight control circuit according to the present embodiment applies electric power to the LEDs 112 through a current controlling part 124. Accordingly, the control part 100, the temperature sensor 102, the counter 104, and the backlight circuit 106 have structures identical to the structures shown in FIG. 1. The current controlling part 124 includes a resistor 126 and a current switch 128 connected to each other in parallel between the voltage source (V+) and the LEDs 112. The current controlling switch 128 is turned on or off by the control part 100 similar to the current controlling switches 122 described with reference to FIG. 1. If the current controlling switch 128 is turned on, the electric power is directly applied to the LEDs 112 without passing through the resistor 126. In contrast, if the current controlling switch is turned off, the electric power is applied to the LEDs 112 through the resistor 126. Accordingly, an amount of current flowing through the LEDs 112 decreases if the current controlling switch 128 is turned off, than when the current controlling switch 128 is turned on. The control part 100 controls the current controlling switch 128 according to a procedure similar to that shown in FIG. 2.

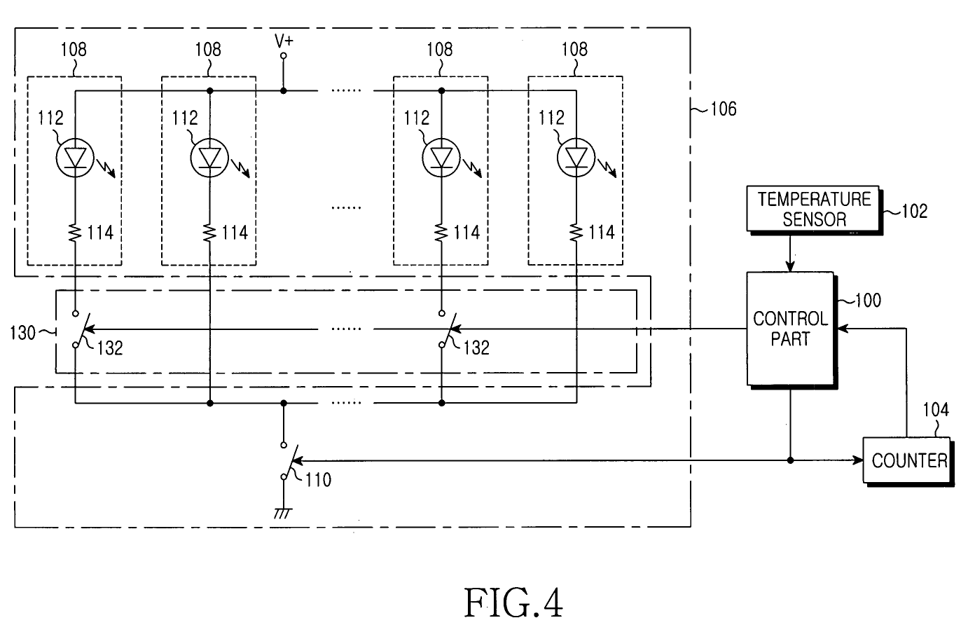

FIG. 4 is a view showing a backlight control circuit according to a third embodiment of the present invention. The backlight control circuit is realized in such a manner that current consumption and thermal emission from the LEDs 112 can be reduced by selectively turning off several of the LEDs 112 in a different manner from that shown with respect to the first embodiment, and the second embodiment which reduce the current consumption and the thermal emission from the LEDs 112 by controlling a volume of the current flowing through the LEDs 112. To this end, an illumination controlling part 130 is used instead of the current controlling part 116 shown in the FIG. 1 or the current controlling part 124 shown in the FIG. 3. Accordingly, the control part 100, the temperature sensor 102, the counter 104, and the backlight circuit 106 have structures identical to the structures shown FIG. 1. The control part 100 turns off a some of the LEDs 112 by means of the illumination controlling part 130 if an illumination time exceeds the reference time or thermal emission is higher than a reference temperature. The illumination controlling part 130 includes illumination controlling switches 132 connected between the backlight controlling switch 110 and a part of plural sets of the LEDs 112 and the resistors 114. Each illumination controlling switch 132 is connected to every other set of the LED 112 and the resistor 114 in FIG. 4. That is, the illumination controlling switches are used for half of plural sets of the LEDs 112 and the resistors 114.

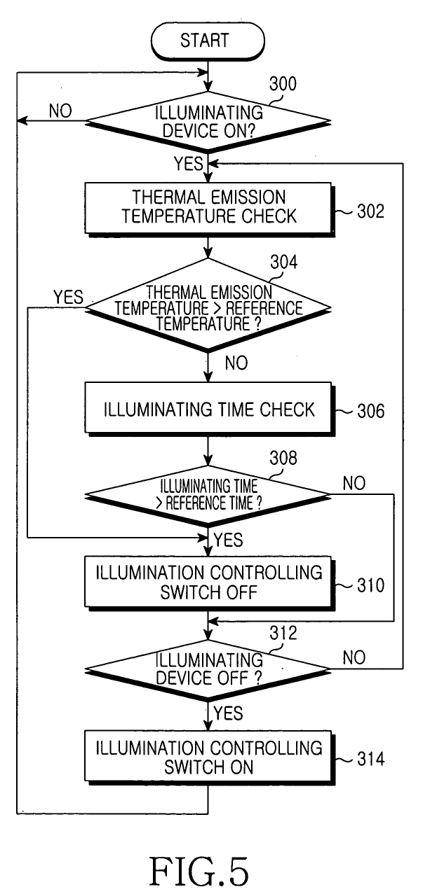

FIG. 5 is a flow chart showing a backlight controlling operation of the control part 100. Herein, the backlight controlling operation occurs with the control part 100 turning off a portion of the LEDs 112 by means of the illumination controlling part 130 if the illumination time exceeds the reference time, or the thermal emission temperature is higher than the reference temperature after checking the thermal emission temperature of the LEDs 112 and illumination time. In the event of executing the backlight function, the control part 100 turns on the illuminating devices LEDs 112 by turning on the backlight controlling switch 110 at step 300. At this time, the illumination controlling switches 132 maintain turn-on states. Also, the counter 104 starts to count the illumination time as the control part 100 turns on the backlight controlling switch 100.

In this state, the control part 100 checks the thermal emission temperature at step 302. If thermal emission temperature of the LEDs 112, which is measured by the temperature, at step 304, sensor 102, is higher than the reference temperature or an illumination time, which is counted by the counter 104 at step 306, exceeds the reference time, the control part 100 switches off the illumination controlling switches 132 at step 310. Otherwise, the control part 100 checks to see if the illuminating devices 112 are off at step 312. When the control part 100 turns off the illumination controlling switches 132 in step 310, some of LEDs, which are connected to the illumination controlling switches 312, are turned off. Thereafter, when the control part 100 checks whether or not the LEDs 112 are turned off in step 312, if all LEDs are turned off according to the termination of the backlight function, the control part 100 returns to step 300 after turning on the illumination controlling switches 132 again in step 314. In contrast, if the control part 110 allows all LEDs to maintain turn-on states as the function of the backlight is continuously executed, or allows the remaining LEDs 112, which are not turned off in step 310, to continuously maintain turn-on states, the control part 100 returns to step 302.

Accordingly, if the thermal emission temperature of the LEDs 112 is higher than the reference temperature, or an illumination time exceeds the reference time as the LEDs 112 continuously maintain turn-on states, the control part 100 turns off some of the LEDs 112, so that it is possible to reduce current consumption resulting from continuous turn-on states of the illuminating devices or to reduce the thermal emission from the LEDs while using the backlight function.

As described above, the present invention reduces a volume of current flowing through illuminating devices or turns off some of the illuminating devices, so that it is possible to save battery power by reducing current consumption resulting from continuous turn-on states of the illuminating devices,and it is possible to prevent users from feeling uneasiness or unpleasantness due to the heat generated by reducing thermal emission from the LEDs while using the illuminating devices.

While the invention has been shown and described with reference to certain preferred embodiments thereof, it will be understood by those skilled in the art that various changes in form and details may be made therein without departing from the spirit and scope of the invention. In particular, according to the present invention, both thermal emission temperature of the illuminating devices and an illuminating time of the illuminating devices are checked. However, according to another embodiment of the present invention, either the thermal emission temperature or the illuminating time can be selectively checked. In addition, although the present invention discloses a plurality of illuminating devices, only one illuminating device can be used in the first and the second embodiments of the present invention. Thus, the scope of the invention should not be limited to the embodiments, but should be defined by the appended claims and equivalents thereof.

1. A backlight control circuit for a portable device including a backlight circuit providing backlight by means of an illuminating device, the backlight control circuit comprising:
a counter for counting an illumination time of the illuminating device when the illuminating device is in a turned-on state;
a current controlling part for controlling a volume of current flowing through the illuminating device; and
a control part for reducing the volume of the current flowing through the illuminating device if the illumination time exceeds a predetermined reference time.

2. The backlight control circuit as claimed in claim 1, wherein the backlight circuit includes at least one pair of an illuminating device and a first resistor connected to each other in series between a voltage source terminal and a ground by interposing a backlight controlling switch for turning on/off the illuminating device between the voltage source terminal and the ground, the current controlling part includes a pair of a second resistor and a current controlling switch, which are connected to each other in series and connected to the first resistor in parallel corresponding to a pair of the illuminating device and the first resistor, and the control part turns off a current controlling switch if the illumination time exceeds the predetermined reference time.

3. The backlight control circuit as claimed in claim 1, wherein the current controlling part includes a resistor connected between a voltage source terminal and the illuminating device and a current controlling switch connected to the resistor in parallel, and the control part turns off the current controlling switch if the illumination time exceeds the predetermined reference time.

4. A backlight control circuit for a portable device including a backlight circuit providing backlight by means of an illuminating device, the backlight control circuit comprising:
a temperature sensor for measuring a thermal emission temperature of the illuminating device;
a current controlling part for controlling a volume of current flowing through the illuminating device; and
a control part for reducing a volume of the current flowing through the illuminating device if the thermal emission temperature is higher than a predetermined reference temperature.

5. The backlight control circuit as claimed in claim 4, wherein the backlight circuit includes at least one pair of an illuminating device and a first resistor connected to each other in series between a voltage source terminal and a ground by interposing a backlight controlling switch for turning on/off the illuminating device between the voltage source terminal and the ground, the current controlling part includes a pair of a second resistor and a current controlling switch, which are connected to each other in series and connected to the first resistor in parallel corresponding to a pair of the illuminating device and the first resistor, and the control part turns off the current controlling switch if the thermal emission temperature is higher than the predetermined reference temperature.

6. The backlight control circuit as claimed in claim 4, wherein the current controlling part includes a resistor connected between a voltage source terminal and the illuminating device and a current controlling switch connected to the resistor in parallel, and the control part turns off the current controlling switch if the thermal emission temperature is higher than the predetermined reference temperature.

7. A backlight control circuit of a portable device including a backlight circuit by means of an illuminating device, the backlight control circuit providing backlight comprising:
a counter for counting an illumination time of the illuminating device when the illuminating device is in a turned-on state;
a temperature sensor for measuring thermal emission temperature of the illuminating device;
a current controlling part for controlling a volume of current flowing through the illuminating device; and
a control part for reducing a volume of the current flowing through the illuminating device if the thermal emission temperature is higher than a predetermined reference temperature, or the illumination time exceeds a predetermined reference time.

8. The backlight control circuit as claimed in claim 7, wherein the backlight circuit includes at least one pair of an illuminating device and a first resistor connected to each other in series between a voltage source terminal and a ground by interposing a backlight controlling switch for turning on/off the illuminating device between the voltage source terminal and the ground, the current controlling part includes a pair of a second resistor and a current controlling switch, which are connected to each other in series, and connected to the first resistor in parallel corresponding to a pair of the illuminating device and the first resistor, and the control part turns off the current controlling switch if the illumination time exceeds the predetermined reference time, or the thermal emission temperature is higher than the predetermined reference temperature.

9. The backlight control circuit as claimed in claim 7, wherein the current controlling part includes a resistor connected between a voltage source terminal and the illuminating device and a current controlling switch connected to the resistor in parallel and the control part turns off the current controlling switch if the illumination time exceeds the predetermined reference time, or the thermal emission temperature is higher than the predetermined reference temperature.

10. A backlight control circuit for a portable device including a backlight circuit provided backlight through a plurality of illuminating devices, the backlight control circuit comprising:
a counter for counting an illumination time of the illuminating devices when the illuminating devices are in a turned-on state;
an illumination controlling part for selectively turning on/off a portion of the illuminating devices; and
a control part for turning off a portion of the illuminating devices if the illumination time exceeds a predetermined reference time.

11. The backlight control circuit as claimed in claim 10, wherein the backlight circuit includes plural pairs of an illuminating device and a resistor connected between a voltage source terminal and a ground in series by interposing the backlight controlling switch for turning on/off the illumination elements between the voltage source terminal and the ground, the illumination controlling part includes illumination controlling switches, which are connected between a portion of pairs of the illuminating device and the resistor and the backlight controlling switch, and the control part turns off the illumination controlling switches if the illumination time exceeds the predetermined reference time.

12. A backlight control circuit for a portable device including a backlight circuit provided backlight through a plurality of illuminating devices, the backlight control circuit comprising:
a temperature sensor for measuring thermal emission temperature of the illuminating devices;
an illumination controlling part for selectively turning on/off a portion of the illuminating devices; and
a control part for turning off a portion of the illuminating devices if the thermal emission temperature is higher than a predetermined reference temperature.

13. The backlight control circuit as claimed in claim 12, wherein the backlight circuit includes plural sets of an illuminating device and a resistor, which are connected between a voltage source terminal and a ground in series, with the backlight controlling switch for turning on/off the illumination elements, the illumination controlling part includes illumination controlling switches, which are connected between a portion of sets of the illuminating device and the resistor and the backlight controlling switch, and the control part turns off the illumination controlling switch if the thermal emission temperature is higher than the predetermined reference temperature.

14. A backlight control circuit for a portable device including a backlight circuit providing backlight through a plurality of illuminating devices, the backlight control circuit comprising:
a counter for counting an illumination time of the illuminating devices when the illuminating devices are in a turned-on state;
a temperature sensor for measuring thermal emission temperature of the illuminating devices;
an illumination controlling part for selectively turning on/off a portion of the illuminating devices; and
a control part for turning off a portion of the illuminating devices if the illumination time exceeds a predetermined reference time, or the thermal emission temperature is higher than a predetermined reference temperature.

15. The backlight control circuit as claimed in claim 14, wherein the backlight circuit includes plural pairs of an illuminating device and a resistor connected between a voltage source terminal and a ground in series by interposing the backlight controlling switch for turning on/off the illumination elements between the voltage source terminal and the ground, the illumination controlling part includes illumination controlling switches, which are connected between a portion of pairs of the illuminating device and the resistor and the backlight controlling switch, and the control part for turning off the illumination controlling switches if the illumination time exceeds the predetermined reference time, or the thermal emission temperature is higher than the predetermined reference temperature.
